(19) United States
(12) Patent Application Publication
(10) Pub. No.: US 2002/0075961 A1
(43) Pub. Date: Jun. 20, 2002

(54) Frame-type dependent reduced complexity video decoding

(75) Inventors: Yingwei Chen, Ossining, NY (US); Zhun Zhong, Stamford, CT (US)

Correspondence Address: Michael E. Marion, Corporate patent Counsel, U.S. Philips Corporation, 580 White Plains Road, Tarrytown, NY, 10591, US

(73) Assignee: PHILIPS ELECTRONICS NORTH AMERICA CORPORATON

(21) Appl. No.: 09/741,720

(22) Filed: Dec. 19, 2000

(51) Int. Cl. H04N 7/12; G06K 9/36

(52) U.S. Cl. 375/240.25; 382/233

(57) ABSTRACT

The present invention is directed to frame-type dependent (FTD) processing in which a different type of processing (including scaling) is performed according to the types (I, B, or P) of pictures or frames being processed. The basis for FTD processing is that errors in B pictures do not propagate to other pictures since decoded B pictures are not used as anchors for the other type of pictures. In other words, since I or P pictures do not depend on B pictures, any errors in a B picture are not spread to any other pictures. Therefore, the present invention puts more memory and processing power to pictures that are most critical to overall video quality.

### BACKGROUND OF THE INVENTION

The present invention relates generally to video compression, and more particularly, to frame-type dependent processing that performs a different type of processing according to the type of pictures or frames being processed.

Video compression incorporating a discrete cosine transform (DCT) and motion prediction is a technology that has been adopted in multiple international standards such as MPEG-1, MPEG-2, MPEG-4, and H.262. Among the various DCT/motion prediction video coding schemes, MPEG-2 is the most widely used, in DVD, satellite DTV broadcast, and the U.S. ATSC standard for digital television.

An example of a MPEG video decoder is shown in FIG. 1. The MPEG video decoder is a significant part of MPEG-based consumer video products. The design goal of such a decoder is to minimize the complexity while maintaining good video quality.

As can be seen from FIG. 1, the input video stream first passes through a variable-length decoder (VLD) 2 to produce motion vectors and the indices to discrete cosine transform (DCT) coefficients. The motion vectors are sent to the motion compensation (MC) unit 10. The DCT indices are sent an inverse-scan and inverse-quantization (ISIQ) unit 6 to produce the DCT coefficients.

Further, the inverse discrete cosine transform (IDCT) unit 6 transforms the DCT coefficients into pixels. Depending on the frame type (I, P, or B), the resulting picture either goes to video out directly (I), or is added by an adder 8 to the motion-compensated anchor frame(s) and then goes to video out (P and B). The current decoded I or P frame is stored in a frame store 12 as anchor for decoding of later frames.

It should be noted that all parts of the MPEG decoder operate at the input resolution, e.g. high definition (HD). The frame memory required for such a decoder is three times that of the HD frame including one for the current frame, one for the forward-prediction anchor and one for the backward-prediction anchor. If the size of an HD frame is denoted as H, then the total amount of frame memory required is 3H.

Video scaling is another technique that may be utilized in decoding video. This technique is utilized to resize or scale the frames of video to the display size. However, in video scaling, not only is the size of the frames changed, but the resolution is also changed.

One type of scaling known as internal scaling was first publicly introduced by Hitachi in a paper entitled “AN SDTV DECODER WITH HDTV CAPABILITY: An ALL-Format ATV Decoder” in the Proceedings of the 1994 IEEE International Conference of Consumer Electronics. There was also a patent entitled “Lower Resolution HDTV Receivers”, U.S. Pat. No. 5,262,854, issued Nov. 16, 1993, assigned to RCA Thompson Licensing.

The two systems mentioned above were designed either for standard definition (SD) display of HD compressed frames or as an intermediate step in transitioning to HDTV. This was due to the high cost of HD display or to reduce the complexity of HD video decoder mainly by operating parts of it at a lower resolution. This type of decoding techniques is referred to as “All format Decoding” (AFD), although the purpose of such techniques is not necessarily to enable the processing of multiple video formats.

### SUMMARY OF THE INVENTION

The present invention is directed to a frame-type dependent (FTD) processing in which a different type of processing (including scaling) is performed according to the type (I, B, or P) of pictures or frames being processed. According to the present invention, a forward anchor frame is decoded with a first algorithm. A backward anchor frame is also decoded with the first algorithm. A B-frame is then decoded with a second algorithm.

Further, according to the present invention, the second algorithm has a lower computational complexity than the first algorithm. Also, the second algorithm utilizes less memory than the first algorithm to decode video frames.

### BRIEF DESCRIPTION OF THE DRAWINGS

Referring now to the drawings were like reference numbers represent corresponding parts throughout:

FIG. 1 is a block diagram of a MPEG decoder;

FIG. 2 is a diagram illustrating examples of different algorithms;

FIG. 3 is a block diagram of the MPEG decoder with external scaling;

FIG. 4 is a block diagram of the MPEG decoder with internal spatial scaling;

FIG. 5 is a block diagram of the MPEG decoder with internal frequency domain scaling;

FIG. 6 is another block diagram of the MPEG decoder with internal frequency domain scaling;

FIG. 7 is a block diagram of the MPEG decoder with hybrid scaling;

FIG. 8 is a flow diagram of one example of the frame-type dependent processing according to the present invention; and

FIG. 9 is a block diagram of one example of a system according to the present invention.

### DETAILED DESCRIPTION

The present invention is directed to frame-type dependent processing that utilizes a different decoding algorithm according to the type of video frame or picture being decoded. Examples of such different algorithms that may be utilized in the present invention are illustrated by FIG. 2. As can be seen, the algorithms are classified as external scaling, internal scaling or hybrid scaling.

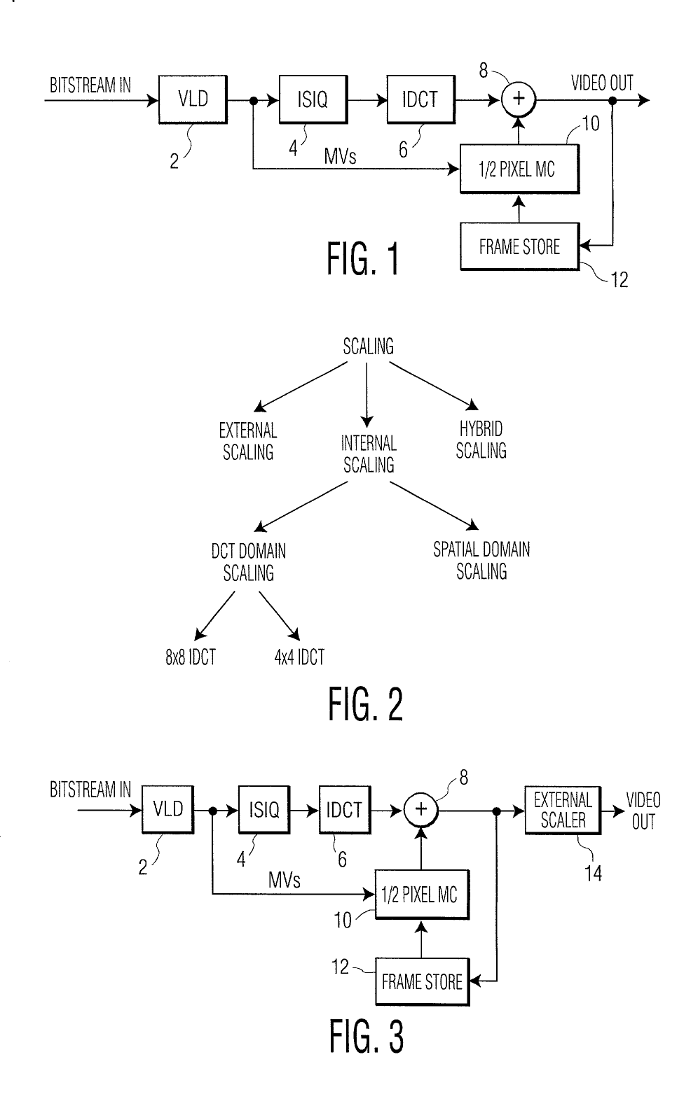

In external scaling, the resizing takes place outside the decoding loop. An example of a decoding algorithm that includes external scaling is shown in FIG. 3. As can be seen, this algorithm is the same as the MPEG encoder shown in FIG. 1 except that an external scaler 14 is placed at the output of the adder 8. Therefore, the input bit stream is first decoded as usual and then is scaled to the display size by the external scaler 14.

In internal scaling, the resizing takes place inside the decoding loop. However, internal scaling can be further classified as either DCT domain scaling or spatial domain scaling.

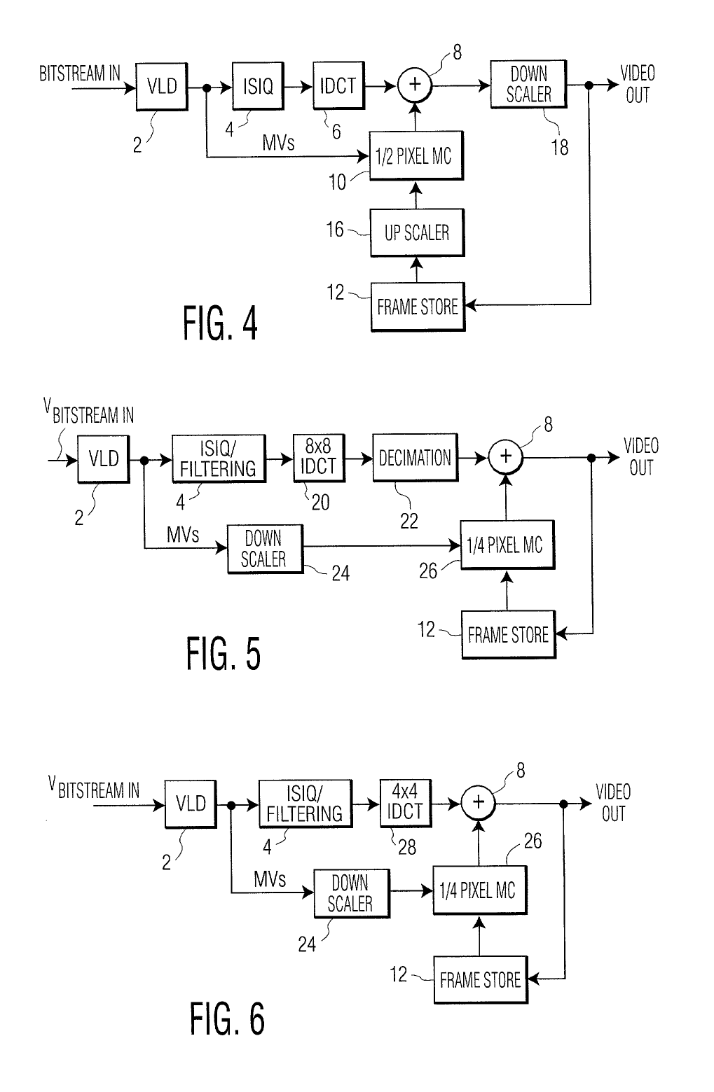

An example of a decoding algorithm that includes internal spatial scaling is shown in FIG. 4. As can be seen, a down scaler 18 is placed between the adder 8 and the frame store 12. Thus, the scaling is performed in the spatial domain before the storage for motion compensation is performed. As can be further seen, an upscaler 16 is also placed between the frame store 12 and MC unit 10. This enables the frames from the MC unit 10 to be enlarged to the size of the frames currently being decoded so that these frames may be combined together.

Examples of a decoding algorithm that includes internal DCT domain scaling is shown in FIGS. 5-6. As can be seen, a down scaler 24 is placed between the VLD 2 and the MC unit 26. Thus, the scaling is performed in the DCT domain before the inverse DCT. Internal DCT domain scaling is further divided into either one that performs 4×4 IDCT and one that performs 8×8 IDCT. The algorithm of FIG. 5 includes the 8×8 IDCT 20, while the algorithm of FIG. 6 includes the 4×4 IDCT 28. In FIG. 5, a decimation unit 22 is placed between the 8×8 IDCT 20 and the adder 8. This enables the frames received from the 8×8 IDCT 20 to be matched to the size of the frames from the MC unit 26.

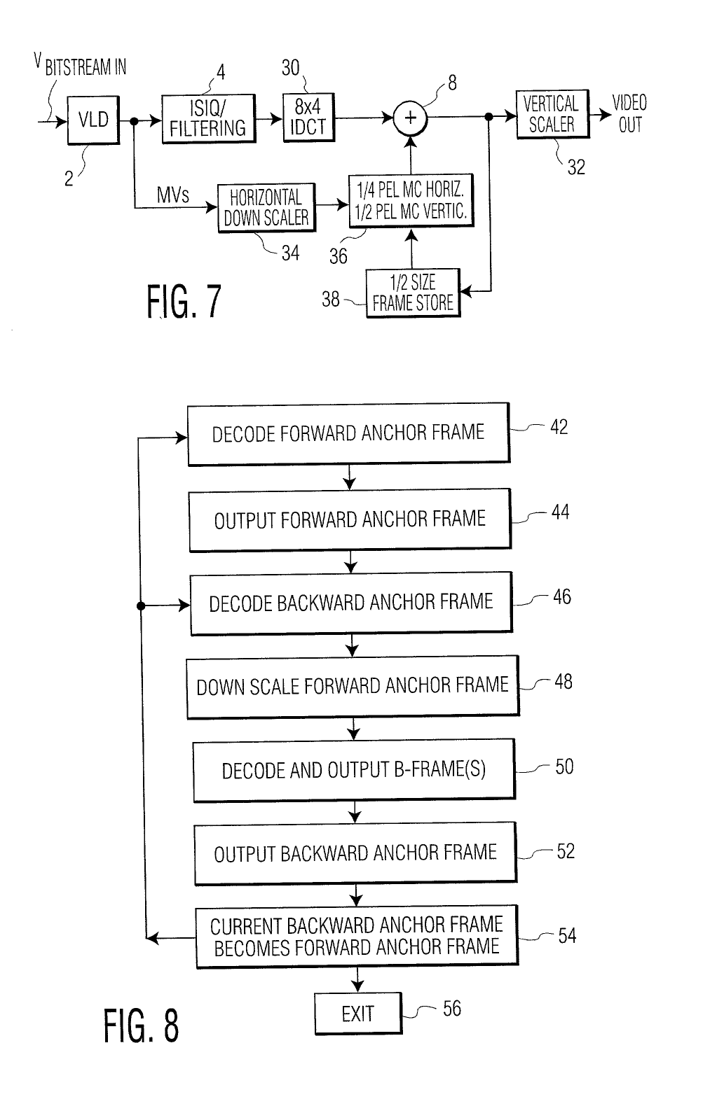

In hybrid scaling, a combination of external and internal scaling is used for the horizontal and vertical directions. An example of a decoding algorithm that includes hybrid scaling is shown in FIG. 7. As can be seen, a vertical scaler 32 is connected to the output of the adder 8 and a horizontal scaler 34 is coupled between the VLD 2 and the MC unit 36. Therefore, this algorithm utilizes internal frequency domain scaling in the horizontal direction and external scaling in the vertical direction.

In the hybrid algorithm of FIG. 7, a scaling factor of two in both directions is presumed. Thus, an 8×4 IDCT 30 is included to account for the horizontal scaling being performed internally. Further, the MC unit 36 also accounts for the internal scaling by providing a quarter pixel motion compensation in the horizontal direction and half pixel motion compensation in the vertical direction.

Each of the above-described decoding algorithms have different memory and computational power requirements. For example, the memory required for external scaling is roughly three times that of a regular MPEG decoder (3H), where the size of an HD frame is denoted as H. The memory required for internal scaling is roughly three times that of a regular MPEG decoder (3H) divided by the scaling factor. Assuming a scaling factor of two for both horizontal and vertical dimensions, which is a likely scenario. Under this assumption, internal scaling uses 3H/4 memory, which is a factor of four reduction compared to external scaling.

In regard to the computational power required, the comparison is more complicated. While internal spatial scaling reduces the amount of memory required, it actually uses more computational power. This is due to the down-scaling for storage and up-scaling for motion compensation, which are both performed in the spatial domain and thus is very expensive to realize especially in software. However, when scaling and filtering are moved to the DCT domain, the computational complexity is reduced significantly because convolution for spatial filtering is converted to multiplication in the DCT domain.

In terms of video quality, the decoder with external scaling such as in FIG. 3 is optimal since the decoding loop is intact. Any technique that performs one or both dimensions of scaling internally alters the anchor frame(s) for motion compensation as compared to that on the encoder side, and thus the pictures decoded deviate from the “correct” ones. Furthermore, this deviation grows as subsequent pictures are predicted from the inaccurately decoded pictures. This phenomenon is commonly referred to as “prediction drift”, which causes the output video to change in quality according to the Group of Pictures (GOP) structure.

In prediction drift, the video quality starts high with an Intra picture and degrades to the lowest right before the next Intra Picture. This periodic fluctuation of video quality, especially from the last picture in one GOP to the next Intra picture, is particularly annoying. The problem of prediction drift and quality degradation is worse if the input video stream is interlaced.

Among all non-hybrid internal scaling algorithms, spatial scaling provides the best quality at the cost of a higher computational complexity. On the other hand, frequency-domain scaling techniques, especially the 4×4 IDCT variation, incurs the lowest computation complexity, but the quality degradation is worse than the spatial scaling.

In regard to hybrid scaling algorithms, vertical scaling contributes the most to quality degradation. Thus, the hybrid algorithm of FIG. 7 including internal horizontal scaling and external vertical external scaling provides very good quality

However, the memory used by this algorithm is half that of full memory, which is twice as much as the non-hybrid internal scaling solutions. Further, the complexity reduction of this hybrid algorithm is less than that of the frequency domain scaling algorithms as well.

It should be noted that the algorithm of FIG. 7 is only one example of a hybrid algorithm. Other scaling algorithms can be mixed to process the horizontal and vertical dimensions of video differently. However, depending on the algorithms combined, the memory and computation requirements may vary.

As stated previously, the present invention is directed to frame-type dependent (FTD) processing in which a different type of processing (including scaling) is performed according to the type (I, B, or P) of pictures or frames being processed. The basis for FTD processing is that errors in B pictures do not propagate to other pictures since decoded B pictures are not used as anchors for the other type of pictures. In other words, since I or P pictures do not depend on B pictures, any errors in a B picture are not spread to any other pictures.

In view of the above, the concept of the FTD processing according to the present invention is that I and P pictures are processed at a higher quality utilizing more memory and a higher complexity algorithm requiring more computational power. This minimizes prediction drift in the I and P pictures to provide higher quality frames. Further, according to the present invention, B pictures are processed at a lower quality with less memory and a lower complexity algorithm requiring less computational power.

In FTD processing, since the I and P frames used to predict the B pictures are of better quality, the quality of B pictures also improve as compared to solutions where all three types of pictures are processed at the same quality. Therefore, the present invention puts more memory and processing power to pictures that are most critical to overall video quality.

According to the present invention, FTD picture processing saves both memory and computational power as compared to frame-type-independent (FTI) processing. This savings can be either static or dynamic depending on if the memory and computational power allocation is worst-case, or adaptive. The discussion below uses memory saving as an example, however, the same argument is valid for computational power savings.

The memory used varies according to the type of pictures being decoded. If an I picture is being decoded, only one (either full or reduced depending on scaling option) frame buffer is required. The I picture stays in memory for decoding later pictures. IF a P picture is being decoded, two frame buffers are needed including one for the anchor (reference) frame (could be I or P depending on whether the current P picture is the first P in the GOP) and the current picture. The P picture stays in memory and together with the previous anchor frame serve as backward and forward reference frames for decoding B pictures. Thus, three frame buffers are needed for decoding B pictures.

As described above, the amount of memory used fluctuates depending on the type of picture being decoded. A significant implication of this memory usage fluctuation is that three frame buffers are needed if memory allocation is worst-case, even though I and P pictures need only one or two frame buffers. This requirement can be loosened if the memory used for B pictures is somehow reduced. In the case of adaptive memory allocation, the “curve” goes down with reduced B frame memory usage.

Similar to memory usage, B pictures may require the most computational power to decode since motion compensation may be performed on two anchor frames as opposed to none for I pictures and one for P pictures. Therefore, the maximum (worst-case) or dynamic processing power requirement can be reduced if B picture processing is reduced.

One example of the FTD processing according to the present invention is shown in FIG. 8. In general, the event flow of the FTD processing for a video sequence is that I and P pictures are decoded with a more complex/better quality algorithm at complexity C₁ and memory usage M₁, while B pictures are decoded with a less complex/lower quality algorithm at complexity C₂ and memory usage M₂. It should be noted that the video sequence being processed may include one or more group of pictures (GOP).

In step 42, the forward anchor frame is decoded with a “first choice” algorithm having a complexity C1. At this time, the decoded forward anchor frame is stored at an X₁ resolution and thus the memory used is X₁. Further, if the forward anchor frame is the first one in a closed GOP, then it will be an I picture. Otherwise, the forward anchor frame is a P picture.

In step 44, the decoded forward anchor frame is output for further processing before being displayed. In step 46, the backward anchor frame is also decoded with the “first choice” algorithm at complexity C₁. At this time, the decoded backward anchor frame is also stored at an X₁ resolution and thus the memory used is X₁+X₁=2X₁. Further, the backward anchor frame is a P picture.

In step 48, the forward anchor frame is down-scaled to the display size having a resolution X₂. At this time, the forward anchor frame can be stored at either the X₁ or X₂ resolution for motion compensation. Since it is assumed that X₁>X₂, storing the forward anchor at the X₂ resolution will save memory. If the forward anchor is stored at X₂ for both MC and output, the memory used is X₁+X₂. If the forward anchor is stored at X₁ for MC, the memory used is X₁+X₁=2X₁.

In step 50, one or more B-frame(s) between the forward and the backward anchor frames are decoded and output. In step 50, the one or more B-frame(s) are decoded with the X₂ resolution forward anchor and the X₁ resolution backward anchor frames using a “second choice” algorithm with a lower complexity C₂. Since the “second choice” algorithm has a lower complexity C₂, the quality of the B picture will not be as good as the other frames, however, the amount of computational power necessary to decode the B picture will also be less. At this time, the decoded B-frame is stored at the X₂ resolution and thus the total memory used is X₁+2X₂.

In step 52, the current forward anchor frame is output for display or further processing. Further, in step 54, the current backward anchor becomes the forward anchor. This will enable the next backward anchor and B frame to be processed.

After step 54, the processing has a number of choices. If there is no more frames left to process in the sequence, the processing will advance to step 56 and exit. If there are more frames left to process in the same GOP, the processing will loop back to step 46. If there are no frames left in the current GOP and the next GOP is not depended on the current GOP (closed GOP), the processing will loop back to step 42 and begin processing the next GOP.

Several observations can be drawn from the above-described FTD processing according to the present invention. Since anchor frames are always decoded with a better quality, less prediction drift occurs in these frames. Also, since X₂<X₁, the memory used for the B pictures or the maximum usage is reduced. Further, since the B pictures are decoded with less complexity, the average computation per frame is reduced.

It should also be noted that the “first choice” and “second choice” algorithm may be embodied by a number of different combinations of known or newly developed algorithms. The only requirement is that the “second choice” algorithm should be of a lower complexity C₂ and use less memory than the “first choice” algorithm having a complexity C₁. Examples of such combinations would include the basic MPEG algorithm of FIG. 1 being used as the “first choice” algorithm and any one of the algorithms of FIGS. 3-7 being used as the “second choice” algorithm.

Other combinations would include the external scaling algorithm of FIG. 3 being used as the “first choice” algorithm along with one of the algorithms of FIGS. 4-7 being used as the “second choice” algorithm. The hybrid algorithm of FIG. 7 may also be used as the used as the “first choice” algorithm along with one of the algorithms of FIGS. 4-6 being used as the “second choice” algorithm. Further, other combinations would also include different filtering options for motion compensation such as polyphase filtering as the “first choice” algorithm and bilinear filtering as the “second choice” algorithm.

In a more detailed example of the FTD processing of FIG. 8, the hybrid algorithm of FIG. 7 is the “first choice” algorithm and the internal frequency domain scaling algorithm of FIG. 6 is the “second choice” algorithm. In this example, a scaling factor of two is assumed for both the horizontal and vertical directions.

In step 42, a forward anchor is decoded with the hybrid algorithm with a computational complexity of C₁ (hybrid complexity). At this time, the decoded forward anchor frame is stored at a resolution H/2 and thus the memory used at this time is H/2. In step 44, the decoded forward anchor frame is output. In step 46, the next backward anchor frame is also decoded with the hybrid algorithm having the computation complexity C₁. At this time, the decoded backward anchor frame is also stored at a resolution H/2 and thus the memory used is H/2+H/2=H.

In step 48, the forward anchor frame is downscaled to a resolution of H/4. Thus, the forward anchor frame may be stored at H/4 or H/2 for motion compensation. The memory used now is H/2+H/4=3H/4 (forward anchor stored at H/4 for MC) or H/2+H/2=H (forward anchor is stored at H/2 for MC).

In step 50, one or more B frame(s) between the forward and the backward anchor frames are decoded and output. In performing step 50, the one or more anchor frames are decoded with the H/2 resolution backward anchor and the H/4 or H/2 resolution forward anchor frame with the internal frequency domain scaling algorithm having a computational complexity of C₂ which is less than C₁. At this time, the decoded B frame is stored at a resolution of H/4 and thus the total memory used is H/2+H/4+H/4=H (H/4 forward anchor) or H/2+H/2+H/4=5H/4 (H/2 forward anchor).

In step 52, the backward anchor frame is output and the current backward anchor becomes the forward anchor in step 54. As previously described, the processing may exit in step 56 or loop back to either steps 42 or 46.

The memory used for the above frame-type-dependent hybrid algorithm (FTD hybrid) never exceeds 5H/4 or H depending on resolution of forward anchor, compared with 3H/2 for the frame-type-independent hybrid algorithm. The computation savings of FTD hybrid are for B pictures only. For a typical M value of three (one anchor frame every three frames), the average computation per frame becomes (C₁+2C₂)/3 compared with C₁ for FTI hybrid.

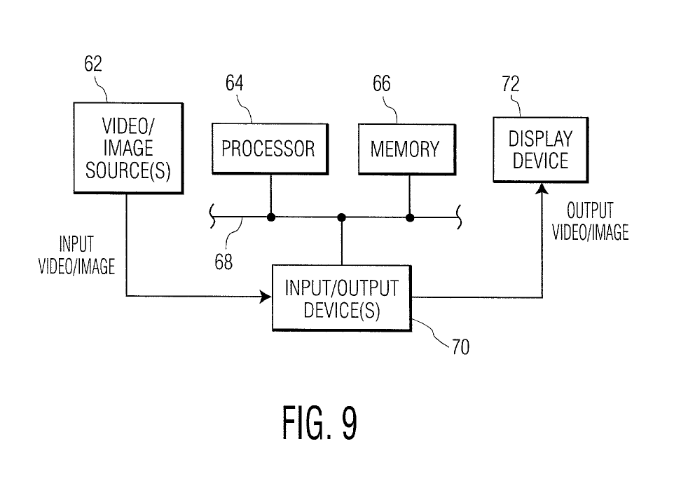

One example of a system in which the FTD processing according to the present invention may be implemented is shown in FIG. 9. By way of example, the system may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system includes one or more video sources 62, one or more input/output devices 70, a processor 64 and a memory 66.

The video/image source(s) 62 may represent, e.g., a television receiver, a VCR or other video/image storage device. The source(s) 62 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 70, processor 64 and memory 66 communicate over a communication medium 68. The communication medium 68 may represent, e.g., a bus, a communication network, one or more internal connections of a circuit, circuit card or other device, as well as portions and combinations of these and other communication media. Input video data from the source(s) 62 is processed in accordance with one or more software programs stored in memory 64 and executed by processor 66 in order to generate output video/images supplied to a display device 72.

In one embodiment, the decoding employing the FTD processing of FIG. 8 is implemented by computer readable code executed by the system. The code may be stored in the memory 66 or read/downloaded from a memory medium such as a CD-ROM or floppy disk. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. For example, the present invention has been described using the MPEG-2 framework. However, it should be noted that the concepts and methodology described herein is also applicable to any DCT/notion prediction schemes, and in a more general sense, any frame-based video compression schemes where picture types of different inter-dependencies are allowed. Therefore, the present invention is intended to cover various structures and modifications thereof included within the spirit and scope of the appended claims.

What is claimed is:

1. A method for decoding video, comprising the steps of:
decoding a forward anchor frame with a first algorithm;
decoding a backward anchor frame with the first algorithm; and
decoding a B-frame with a second algorithm.

2. The method of claim 1, wherein the second algorithm has a lower computational complexity than the first algorithm.

3. The method of claim 1, wherein the second algorithm utilizes less memory than the first algorithm to decode video frames.

4. The method of claim 1, further comprising down scaling the forward anchor frame to a reduced resolution.

5. The method of claim 4, further comprising storing the forward anchor frame at the reduced resolution.

6. The method of claim 1, further comprising discarding the forward anchor frame.

7. The method of claim 6, further comprising making the backward anchor frame a second forward anchor frame.

8. The method of claim 1, wherein the forward anchor frame is either an I frame or a P frame.

9. The method of claim 1, wherein the backward anchor frame is a P frame.

10. A memory medium including code for decoding video, the code comprising:
a code to decode a forward anchor frame with a first algorithm;
a code to decode a backward anchor frame with the first algorithm; and
a code to decode a B-frame with a second algorithm.

11. An apparatus for decoding video, comprising:
a memory which stores executable code; and
a processor which executes the code stored in the memory so as to (i) decode a forward anchor frame with a first algorithm, (ii) decode a backward anchor frame with the first algorithm, and iii) decode a B-frame with a second algorithm.
